(19) United States
(12) Patent Application Publication
(10) Pub. No.: US 2008/0173135 A1
(43) Pub. Date: Jul. 24, 2008

(54) Bottle Opener

(76) Inventor: Richard L. Beard, Portland, ME (US)

Correspondence Address: BOHAN MATHERS, PO BOX 17707, PORTLAND, ME, 04112-8707, US

(21) Appl. No.: 11/749,593

(22) Filed: May 16, 2007

Related U.S. Application Data
(63) Continuation-in-part of application No. 11/656,683, filed on Jan. 23, 2007, now abandoned.

(51) Int. Cl. B67B 7/44

(52) U.S. Cl. 81/3.09

(57) ABSTRACT

Bottle opener having two through-slots that allow it to be threaded onto a strap, such as the adjustment strap of a baseball cap or a strap loop on a beverage cooler. The bottle opener may include additional features, such as a retainer or magnet for a golf ball marker, another magnet to prevent a removed bottle cap from falling to the ground. A small instrument, such as a compass, a watch, or a temperature indicator, may be mounted on the bottle opener.

### BACKGROUND INFORMATION

1. Field of the Invention

The invention relates to the field of bottle openers, in particular, to openers for the crown cork type bottle cap. More particularly, the invention relates to a bottle opener that is carried on apparel or sports gear.

2. Description of the Prior Art

Bottle openers are well known. They are typically small in size and, because of that, they are easily misplaced or difficult to locate when needed. It is common to attach a bottle opener to a key chain, so that a person can carry it with him. This is a practical solution for many situations, but there are still many times when a person does not carry his personal keys with him, for example, at the beach or at a picnic, but where a bottle opener may be needed.

What is needed, therefore, is a bottle opener that is easily worn or carried on wearing apparel or sports or recreational gear.

### BRIEF SUMMARY OF THE INVENTION

The invention is a bottle opener constructed to be carried on a strap, for example, the adjustment strap of a baseball cap, the strap of a backpack, cooler straps, a belt, etc.

The bottle opener is constructed as a single bar, having at least two through-slots for threading the bar onto a strap, and a cap opener formed in a portion of the bar. Ideally, the bar of the bottle opener is curved slightly, to accommodate the shape of a person's head or torso, if the intended purpose is to carry the bottle opener on the strap of a baseball cap or on a belt. The bottle opener is operational, without first having to remove it from the strap or the belt.

The bottle opener is made of a durable, rugged, form-rigid material, such as a metal or a hard plastic material.

### BRIEF DESCRIPTION OF THE DRAWINGS

The present invention is described with reference to the accompanying drawings. In the drawings, like reference numbers indicate identical or functionally similar elements. The drawings are not necessarily to scale.

FIG. 1 is a top plane view of a first embodiment of the bottle opener according to the invention.

FIG. 2 shows the bottle opener of FIG. 1 mounted on the strap of a baseball cap.

FIG. 3A is a side plane view of the bottle opener of FIG. 1, showing a flat bar.

FIG. 3B is a side plane view of the bottle opener of FIG. 1, showing a continuously curved contour.

FIG. 3C is a partial cross-sectional drawing, showing a metal blade on the bevel edge of the cap opener.

FIG. 4 is a top plane view of a second embodiment of the bottle opener according to the invention.

FIG. 5 is a top plane view of a third embodiment of the bottle opener according to the invention.

FIG. 6A is a top plane view of a fourth embodiment, showing the two through-slots separated by the strap bar.

FIG. 6B is a bottom plane view of the embodiment of FIG. 6A, showing a series of depressions.

FIG. 7 is a partial cut-away view of the fourth embodiment, showing a recessed strap bar.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

FIG. 1 shows a first embodiment of a bottle opener 100 according to the invention, which is intended to be carried on a strap. The term “strap” used hereinafter is representative of any strap, such as a strap on the back of a baseball cap or feedcap, a cooler strap, the strap of a backpack, or a belt. The bottle opener 100 is formed as a bar 110 with ends 112A and 112B, a cap opener 102, and first and second through-slots 104 and 106 for threading the bottle opener 100 onto a strap. In the embodiment shown, the first and second through-slots 104 and 106 are formed at the ends 112A and 112B. This allows the bottle opener 100 to be threaded onto a strap, such that the opener does not swing freely from the strap. Placement of the through-slots, however, is not limited to the ends of the bar 112A and 1126, as will be shown in another embodiment below. It is understood that the shape of the bottle opener 100 is not limited to a general rectangular shape, but may, instead, have a fanciful or decorative shape, such as that of a fish, surfboard, snowboard, football, race car, etc. For example, the dashed lines in FIG. 1 illustrate the bottle opener 100 shaped like a football.

The cap opener 102 has a bevel edge 102A along one side and a leverage surface 103 along an opposite side. The bevel edge 102A fits under the edge of a crown cork bottle cap, while the leverage surface 103 rests on the top of the bottle cap and serves as a leverage point to lift off the cap. The cap opener 102 may include a magnet or magnetized area 116A for retaining the bottle cap after removing it from the bottle. In a preferred embodiment, the magnet 116A is located on the leverage surface 103, but it is understood that it may be any appropriate place on the cap opener 102. The bar 110 has a grip portion 114, which lends itself as a branding area 118 that is used to carry branding information, such as a logo, trademark, trade name, product image, or other such advertising information. The branding area 118 may also include a retainer 122 for holding a golf ball marker M. The retainer 122 may be a provided as a magnet 116B or magnetized area on the bar 110, or as a lip 122 that forms a pocket or channel into which the golf ball marker M is placed. A useful instrument 120, such as a compass, a watch, a temperature indicator, or other type of small device, may be mounted on or incorporated into the bottle opener 100. Hikers, for example, may appreciate a bottle opener that includes a compass.

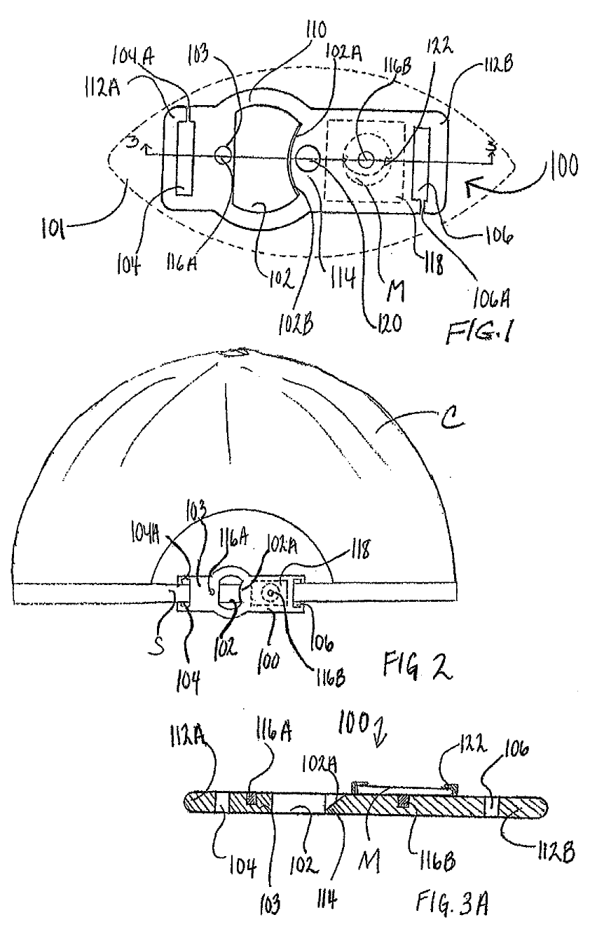

FIG. 2 illustrates the bottle opener 100 threaded onto an adjustment strap S of a baseball cap C. Ideally, the strap S is threaded through the first and second through-slots 104 and 106 such that the strap S remains behind the cap opener 102. The shape and size of the through-slots 104 and 106 are designed to accommodate the particular type of strap intended for use. For example, a relatively thin, rectangular opening is suitable for threading the bottle opener 100 onto the strap S of a baseball cap. Wider through-slots may be formed, if the intended purpose is to carry the bottle opener 100 on a backpack strap or on a belt. Some straps are attached at each end to a device to form a loop, such as strap loops on a cooler. The through-slots 104 and 106 may include breakthroughs 104A and 106A, respectively, which enable such strap loops to be slipped into the corresponding through-slot 104, 106.

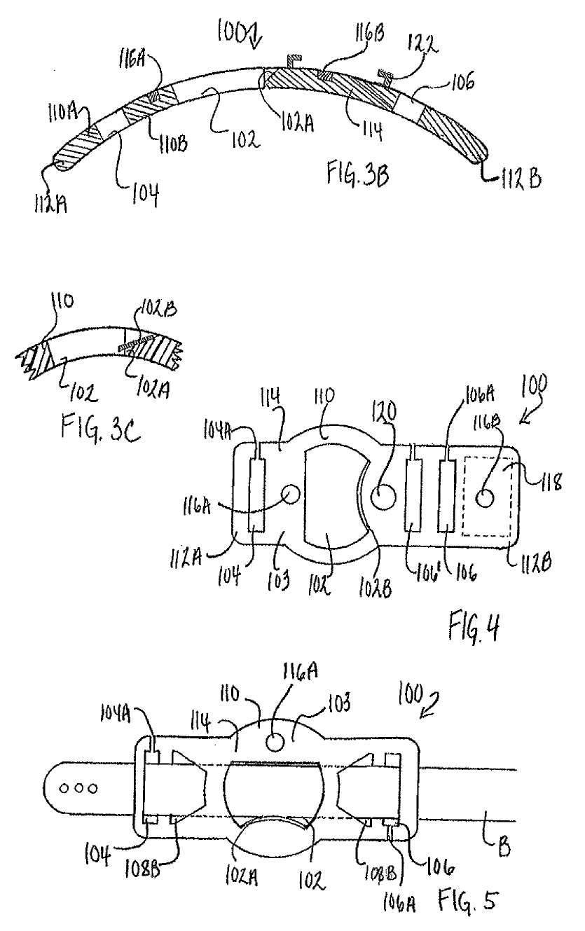

FIGS. 3A and 3B show cross-sectional side views of the bottle opener 100. Ideally, the bottle opener 100 has a slightly curved contour, as shown in FIG. 3B, which corresponds approximately to the curvature of the back of a person's head. Accordingly, an outer surface 110A of the bar 110 is convex and an inner surface 110B is concave. This ensures that the bottle opener 100 feels comfortable when it is threaded onto the adjustment strap S of a baseball cap and the cap is worn on the head. Alternatively, the bottle opener 100 may be provided as a flat bar, as shown in FIG. 3A, particularly if the intended use is to thread the opener onto a backpack or cooler strap.

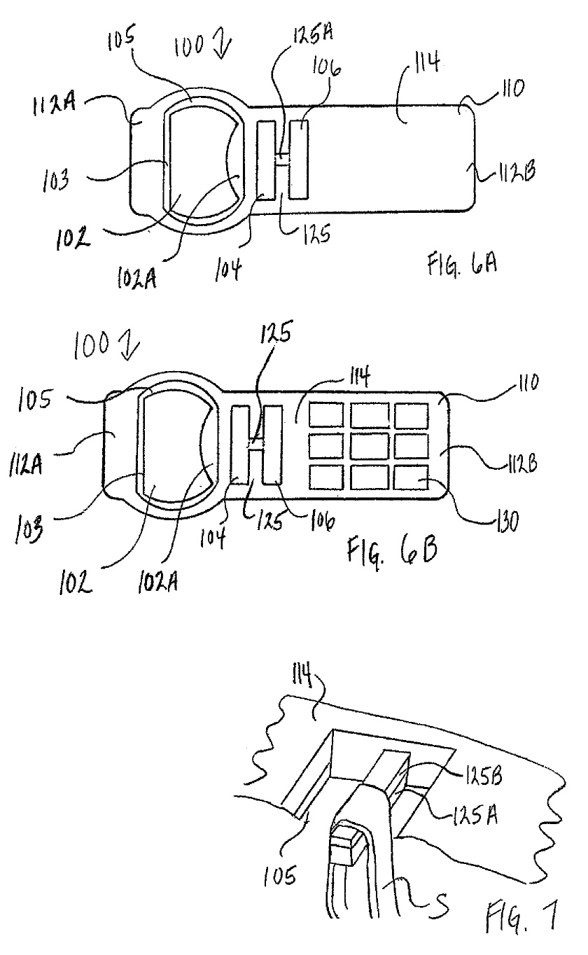

FIGS. 4 and 5 illustrate further embodiments of the bottle opener 100. In the embodiment shown in FIG. 4, multiple through-slots 106 are provided, designated 106 and 106′. FIG. 5 illustrates a different orientation of the cap opener 102 that is particularly suitable for carrying on a belt B. The user threads the belt B through the first through-slots 104 and 106, such that the belt B remains behind the cap opener 102. The bottle opener 100 is ideally placed on the belt B such that the leverage surface 103 is above the bevel edge 102A. With this orientation, the user simply places the crimped edge of the bottle cap onto the bevel edge 102A, rotates the lower portion of the bottle upward while forcing the cap against the leverage surface 103 to lift the cap off the bottle. The magnetized area 116A of the cap opener 102 prevents the cap from falling to the ground. Additional cut-outs or through-slots may be provided, in various shapes and sizes, such as additional through-slots 108A and 108B, shown in FIG. 5.

FIGS. 6A and 6B illustrate a further embodiment of the bottle opener 100. In this embodiment, the through-slots 104 and 106 are placed close together in the grip portion 114. A strap bar 125 allows the strap S to be threaded through the two through-slots 104, 106. The strap bar 125 may have a breakthrough 125A, in order to allow a strap loop to be slipped onto it, as shown, or may be a continuous bar, as indicated by dashed lines in the break-through area. FIG. 7 shows a cut-away, perspective view of this fourth embodiment, threaded onto a strap S, which in this case is a strap loop. The strap bar 125 is recessed from the top plane of the grip portion 114, to accommodate the thickness of the strap S, for reasons of comfort and for aesthetics.

The bottle opener 100 is constructed of a durable, rugged, and form-rigid material that is strong enough to withstand the force of opening a bottle, for example, a metal or a hard plastic material. If the bar 110 is a molded plastic piece, a series of depressions 130 may be formed in the bottom surface, as shown in FIG. 6B. These depressions 130 reduce the amount of material, but also prevent the formation of dips on the upper surface, which is the branding area 118, such dips being a frequent occurrence during the cool-down phase. A combination of plastic and metal material may also be used. For example, the bar 110 is formed of a hard plastic material, with a metal blade 102B affixed to the bevel edge 102A of the cap opener 102, as shown in FIG. 3C. Certain areas of the bar 110 that are subject to high force, such as the cap opener 102 or the grip portion 114, may be reinforced with metal. For example, a reinforcing metal insert 105 is incorporated into the opening for the cap opener, shown in FIGS. 6A and 6B. The strap bar 125 may comprise a reinforcing layer 125A of metal and a base layer 125B of plastic, as shown in FIG. 7. The strap on which the bottle opener 100 is carried is typically made of a flexible material. This allows the bottle opener 100 to be used to open bottle caps, without having to first remove it from the strap. The wearer of the baseball cap simply removes his cap, grabs the bottle opener in a typical fashion and uses it to lift off a crown cork type bottle cap.

It is understood that the embodiments described herein are merely illustrative of the present invention. Variations in the construction of the bottle opener may be contemplated by one skilled in the art without limiting the intended scope of the invention herein disclosed and as defined by the following claims.

1. A bottle opener comprising:
a bar having at least two through-slots adapted to allow a strap to be threaded through said at least two through-slots for securing said bar to said strap, with a bottle cap opener formed in said bar, wherein said bottle cap opener includes an opening bounded by a bevel edge on one side and a leverage surface on an opposite side and
a first magnet disposed on said leverage surface, for holding a bottle cap against said bar after said bottle cap has been removed from a bottle with said bottle cap opener.

2. The bottle opener of claim 1, wherein said central portion of said bar is curved.

3. The bottle opener of claim 1, wherein said bar has a curved inner surface.

4. The bottle opener of claim 1, wherein said bar is flat.

5-7. (canceled)

8. The bottle opener of claim 1, wherein a metal blade is affixed to said bevel edge.

9. The bottle opener of claim 1, wherein said through-slot includes a break through.

10. The bottle opener of claim 1 wherein said two through-slots are placed adjacent one another, with a strap bar therebetween, so as to allow a strap to be threaded through said two through-slots around said strap bar.

11. The bottle opener of claim 101 wherein said strap bar has a breakthrough for allowing a strap loop to be slipped over a portion of said strap bar.

12. (canceled)

13. The bottle opener of claim 1, further comprising a second magnet for holding a golf ball marker against said bar.

14. The bottle opener of claim 1, further comprising a retaining channel for retaining a golf ball marker.

15. (canceled)

16. The bottle opener of claim 1 further comprising an instrument mounted on said bar.

17. The bottle opener of claim 16, wherein said instrument includes any one or more of a watch, a compass, and a thermometer.

18. A bottle opener comprising:
a bar having at least two through-slots adapted to allow a strap to be threaded through said at least two through-slots for securing said bar to said strap, with a bottle cap opener formed in said bar, wherein said two through-slots are placed adjacent one another, with a strap bar therebetween, so as to allow a strap to be threaded through said two through-slots around said strap bar.

19. The bottle opener of claim 18, wherein said strap bar has a breakthrough for allowing a strap loop to be slipped over a portion of said strap bar.

20. The bottle opener of claim 18, wherein said central portion of said bar is curved.

21. The bottle opener of claim 18, wherein said bar has a curved inner surface.

22. The bottle opener of claim 18, wherein said bar is flat.

23. The bottle opener of claim 18, wherein said bottle cap opener includes an opening bounded by a bevel edge on one side and a leverage surface on an opposite side, said bottle opener further comprising a first magnet disposed on said leverage surface, for holding a bottle cap against said bar after said bottle cap has been removed from a bottle with said bottle cap opener.

24. The bottle opener of claim 18, further comprising a second magnet for holding a golf ball marker against said bar.

25. The bottle opener of claim 18, further comprising a retaining channel for retaining a golf ball marker.
